(19) United States
(12) Patent Application Publication
(10) Pub. No.: US 2002/0135474 A1
(43) Pub. Date: Sep. 26, 2002

(54) Method and device for sensor-based power management of a consumer electronic device

(76) Inventor: Douglas G. Sylliassen, Escondido, CA (US)

Correspondence Address: WAGNER, MURABITO & HAO LLP, Third Floor, Two North Market Street, San Jose, CA, 95113, US

(21) Appl. No.: 09/814,538

(22) Filed: Mar. 21, 2001

(51) Int. Cl. G08B 13/00

(52) U.S. Cl. 340/540; 340/545.2

(57) ABSTRACT

A method and device thereof for automatically turning an electronic device off. A motion sensor detects a level of motion in a predetermined area containing the electronic device. A heat sensor detects a level of heat within the same area. In one embodiment, upon the level of motion falling below a user-defined minimum threshold, the electronic device automatically turns off. In another embodiment, upon the level of heat falling below a user-defined minimum threshold, the electronic device automatically turns off. In another embodiment, once the level of motion or level of heat falls below a user-defined threshold, a timer is activated. Upon the passing of a first predetermined time period, the electronic device automatically turns off. In another embodiment, a warning signal is issued at a second predetermined time for notifying a user that upon the passing of the first predetermined time the electronic device will automatically shut off. Thus, the present invention automatically turns off an electronic device when it is not in use.

### FIELD OF INVENTION

The present invention relates to the field of consumer electronic devices. In particular, the present invention relates to sensor-based power management of consumer electronic devices.

### BACKGROUND OF THE INVENTION

In recent years, various consumer electronic devices have become increasingly prevalent in homes. It is common for one household to have several television sets, as well as a video cassette recorder (VCR), a digital video disc (DVD) player, a stereo receiver, a compact disc (CD) player, a cassette deck, and numerous other consumer electronic devices.

Televisions, as well as the consumer electronic devices mentioned above, operate in a passive mode. For example, once a viewer turns on a television, the television has no way of determining whether or not the viewer is actually watching the television or is in another room. Consumer electronic devices that operate in passive mode require no user interaction to operate, apart from turning them on. As a result, even if the consumer electronic device is not being used, the device will remain on until a user turns it off. This causes the device to continue to use power despite it not being used.

This problem is especially prevalent in homes with multiple televisions and children. Often, a child will turn on a television and then leave the room without turning the television off. This causes wear on the inner components of the television as well as causing the television to continue to consume power despite not being used by a viewer. Televisions, as most other electronic devices, have components that deteriorate with use. As such, the life span of a television declines when it is turned on. Furthermore, even when a television is not being used, it continues to consume power that must be paid for.

Presently, many television models by numerous manufacturers incorporate an automatic shutdown (e.g., sleep) function. This automatic shutdown function is typically used to shut off a television at the end of a specified time period. For example, this function is useful for when an individual desires to fall asleep to the television. Upon the passing of a specified time period, the television will shut off automatically.

However, the automatic shutdown function is not useful to solve the problem of televisions being left on despite not being viewed. The automatic shutdown function typically requires a user to specify a countdown time. Clearly, the situation of viewers leaving the room and forgetting to turn the television off defeats the purpose of entering a countdown time. Furthermore, the user interface for the automatic shutdown function is typically very complicated, requiring a user to understand and operate several menus and variables. As a result, countdown timers are rarely used in practice.

### SUMMARY OF THE INVENTION

Accordingly, a need exists for a method and a device thereof for detecting use and for automatically turning off a passively used electronic device when it is not being used. A need also exists for a method and a device thereof that accomplishes the above need and is user friendly and convenient for a user to operate. A need also exists for a method and a device thereof that accomplishes the above needs and can be integrated into current consumer electronic devices. A need also exists for a method and a device thereof that accomplishes the above needs and is commercially economical.

A method and device are discussed for automatically turning an electronic device off. A motion sensor detects a level of motion in a predetermined area containing the electronic device. A heat sensor detects a level of heat within the same area.

In one embodiment, upon the level of detected motion falling below a user-defined minimum threshold, the electronic device automatically turns off. Upon the level of motion falling below a minimum threshold, the electronic device infers that no one is in the room at which the electronic device is located. Thus, no one is using the electronic device and the electronic device automatically shuts off.

In another embodiment, upon the level of detected heat falling below a user-defined minimum threshold, the electronic device automatically turns off. Upon the level of heat falling below a minimum threshold, the electronic device infers that no one is in the room at which the electronic device is located. Thus, no one is using the electronic device and the electronic device automatically shuts off.

In another embodiment, upon both the level of detected motion falling below a user-defined minimum threshold and the level of detected heat falling below a user-defined minimum threshold, the electronic device automatically turns off. The electronic device infers that no one is in the room at which the electronic device is located. Thus, no one is using the electronic device and the electronic device automatically shuts off.

In another embodiment, once the level of detected motion or level of detected heat falls below a user-defined threshold, a timer is activated. Upon the passing of a first predetermined time period, the electronic device automatically turns off.

In another embodiment, at a second predetermined time a warning signal is issued for notifying a user that upon the passing of the first predetermined time the electronic device will automatically shut off.

The present invention provides for a method and a device thereof for automatically turning off a passively used electronic device when it is not being used, therefore reducing power costs and wear on the components of the electronic device. The present invention also provides for a method and a device thereof that is user friendly and convenient for a user to operate. The present invention also provides for a method and a device thereof that is readily integrated into current consumer electronic devices. The present invention also provides for a method and a device thereof that is commercially economical.

These and other objects and advantages of the present invention will become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates an exemplary electronic device upon which embodiments of the present invention may be practiced.

FIG. 2 is a block diagram illustrating a thresholding operation for determining threshold sensitivity levels in accordance with one embodiment of the present invention.

FIG. 3 illustrates an exemplary user interface for entering user-defined sensitivity levels for use in setting threshold levels in accordance with one embodiment of the present invention.

FIGS. 4A and 4B are flowcharts showing steps of a process for generating an “off” signal for an electronic device when motion falls below a threshold level in accordance with one embodiment of the present invention.

FIGS. 5A and 5B are flowcharts showing steps of a process for generating an “off” signal for an electronic device when temperature falls below a threshold level in accordance with one embodiment of the present invention.

FIG. 6 is a block diagram illustrating an operation for turning off an electronic device upon the generation of off signals in accordance with one embodiment of the present invention.

### DETAILED DESCRIPTION

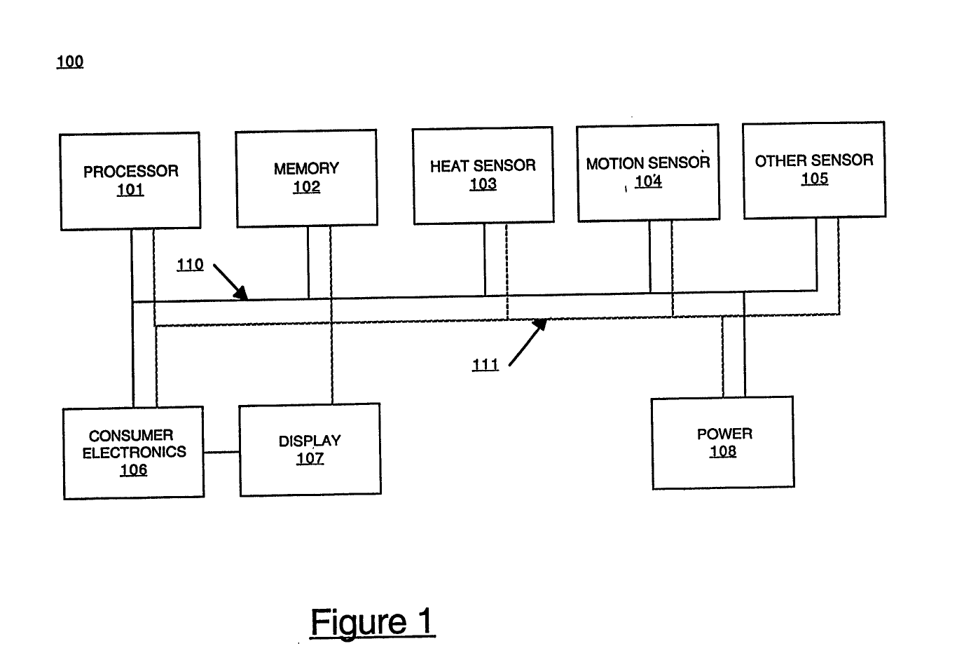

Refer now to FIG. 1 which illustrates an exemplary electronic device 100 upon which embodiments of the present invention may be practiced. In general, electronic device 100 comprises data bus 110 for communicating information, processor 101 coupled with data bus 110 for processing information and instructions, memory 102 coupled with data bus 110 for storing information and instructions for processor 101, heat sensor 103 coupled With data bus 110 for monitoring temperature, motion sensor 104 coupled with data bus 110 for monitoring motion, and other sensor 105 coupled with data bus 110 for monitoring other conditions. It should be appreciated that other sensor 105 is intended include any other sensor that may be used for detecting environmental conditions indicative of a person or persons using electronic device 100, such as a sound sensor or a light sensor, etc.

In one embodiment, electronic device 100 also comprises consumer electronics 106 (e.g. television) coupled with data bus 110 for receiving and interpreting television data and display 107 coupled to consumer electronics 106 for displaying television data. It should be appreciated that consumer electronics 106 can be replaced with the electronics for any electronic device and that display 107 can be replaced with another output component. Thus, the present invention is configured to operate in any number of electronic devices, including but not limited to a television, a VCR, a DVD player, a stereo receiver, a CD player, a cassette deck, a set-top box, etc.

Electronic device 100 also comprises power supply 108 coupled to data bus 110. Power supply 108 is also coupled to power bus 111. Power bus 111 is coupled to processor 101, memory 102, heat sensor 103, motion sensor 104, other sensor 105, consumer electronics 106, and display 107 for providing power to these components.

Typical sensor component technology, such as that used in heat sensor 103 and motion sensor 104, is inexpensive, and can be integrated into existing electronic devices at a low cost per unit.

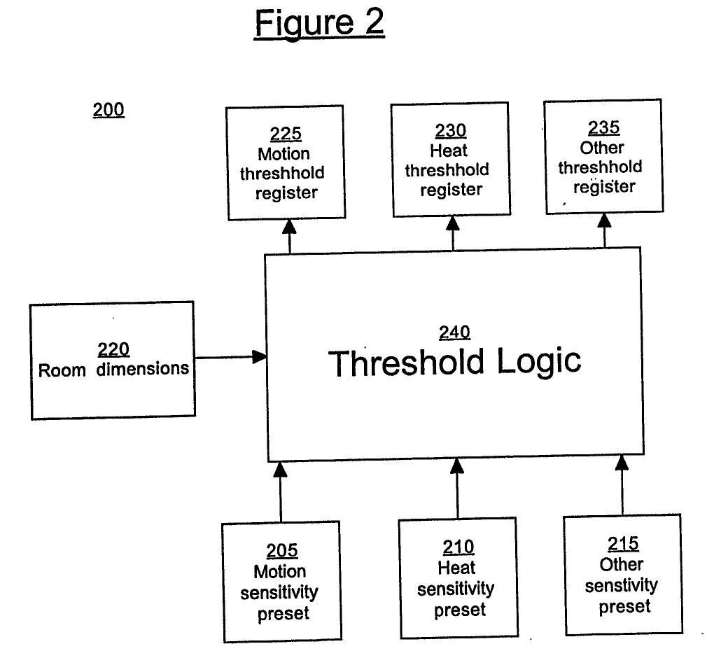

FIG. 2 is a block diagram illustrating a thresholding operation 200 for determining threshold levels in accordance with one embodiment of the present invention. Thresholding operation 200 is an operation or thread that runs parallel to other programs and circuitry operating on an electronic device. Threshold logic 240 (which can be implemented as software or hardware) determines threshold levels by performing calculations based on a number of input values. In one embodiment, the input values are user-defined. In one embodiment, thresholding operation 200 is run every time a user modifies any input value (e.g. threshold level).

In one embodiment, the user-defined presets include motion sensitivity preset 205, heat sensitivity preset 210, and room dimensions 220. In another embodiment, the user-defined presets may include other sensitivity preset 215, to account for additional environment sensors.

Motion sensitivity preset 205 permits a user to define a threshold sensitivity level for detecting motion. For example, a user may desire that the automatic shutdown process be very sensitive such that even the slightest motion (e.g. a person inhaling and exhaling) exceeds the threshold level. Conversely, a user may desire low sensitivity such that a substantial motion (e.g. waving an arm) is required to exceed the threshold level, so as to account for household pets, etc.

Heat sensitivity preset 210 permits a user to define a threshold sensitivity level for a temperature reading. A heat sensor (e.g. heat sensor 103 of FIG. 1) allows for an inference that if the temperature reading falls below a threshold level, that there are no users in the room where the electronic device is located. For example, a user may desire that the automatic shutdown feature not be activated when there are people in the room where the electronic device is located, even if a motion sensor (e.g. motion sensor 104 of FIG. 1) detects no motion.

Other sensitivity preset 215 is intended to account for other sensors residing in an electronic device (e.g. other sensor 105 of FIG. 1) for activating an automatic shutdown process. In one embodiment, other sensitivity 215 may allow for a user to define a sound threshold level. For example, a user may desire that the automatic shutdown feature be activated if the level of sound falls below a sound threshold level. In one embodiment, this would require additional electronics to disregard the sound emitted by the electronic device itself, and only account for the ambient sound. In another embodiment, other sensitivity 215 may allow for a user to define a light threshold level. For example, a user may desire that the automatic shutdown feature be activated if the light surrounding the device falls below a light threshold level (e.g. a person turns a room light off).

Room dimensions 220 allows for threshold logic 240 to account for the size dimensions of different sized rooms in calculating a threshold sensitivity level. Threshold logic 240 calculates an appropriate threshold level by performing a normalization calculation on the sensitivity presets (e.g. motion sensitivity preset 205 and heat sensitivity preset 210) using room dimensions 220 input. This calculation accounts for the differing properties of motion and heat in different sized rooms. For example, for larger rooms threshold logic 240 would increase the sensitivity of heat and motion because users can be farther away from the electronic device. Likewise, for smaller rooms threshold logic 240 would decrease the sensitivity to heat and motion because users will be closer to the electronic device. In one embodiment, the electronic device (e.g. electronic device 100 of FIG. 1) can automatically determine room dimensions 220.

Upon calculating an appropriate threshold sensitivity level, threshold logic 240 stores the result in a register. Motion threshold register 225 stores the motion threshold level and heat threshold register 230 stores the heat threshold level. Other register 235 stores any other threshold sensitivity levels supported by the electronic device. It should be appreciated that there can be more than one other register 235.

The threshold levels allow a user to define the particular settings that are appropriate to their individual viewing habits and room dimensions. The present invention operates to automatically shutdown an electronic device if no user is interacting with the electronic device. Given input from the user settings, the electronic device would activate an automatic shutdown process when certain viewing thresholds were not met, such as no movement for a period of time, or no user in the vicinity of the electronic device for a period of time (e.g. no user is interacting with the device).

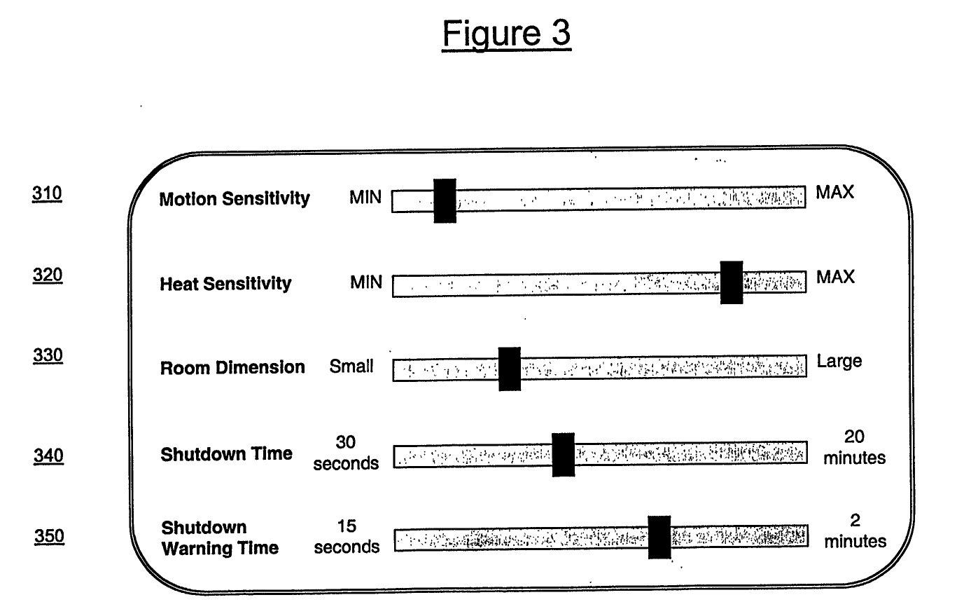

FIG. 3 illustrates an exemplary user interface display 300 for entering user-defined sensitivity levels for use in setting threshold levels in accordance with one embodiment of the present invention. The threshold levels allow a user to define the particular settings that are appropriate to their individual viewing habits and room dimensions. Given input from the user settings, the electronic device would activate an automatic shutdown process when certain viewing thresholds were not met, such as inactivity for a period of time.

User interface display 300 allows a user to define several settings (e.g. using slide bars or tabs) for operating an automatic shutdown process. Motion sensitivity setting 310 allows a user to adjust and define a threshold level for detecting motion (e.g. motion sensitivity preset 205 of FIG. 2). In response to a user increasing motion sensitivity setting 310, the motion threshold level decreases such that less motion is required to exceed the threshold level (e.g. greater sensitivity to motion). Likewise, in response to a user decreasing motion sensitivity setting 310, the motion threshold level increases such that more motion is required to exceed the threshold level (e.g. less sensitivity to motion).

Heat sensitivity setting 320 allows a user to adjust and define a threshold level for detecting temperature (e.g. heat sensitivity preset 210 of FIG. 2). In response to a user increasing heat sensitivity setting 320, the heat threshold level decreases such that less heat is required to exceed the threshold level (e.g. greater sensitivity to temperature). In this instance, less heat is needed to exceed the threshold level. Likewise, in response to a user decreasing heat sensitivity setting 320, the heat threshold level increases such that more heat is required to exceed the threshold level (e.g. less sensitivity to temperature).

Room dimension setting 330 allows a user to account for the size dimensions of a room (e.g. room dimensions 220 of FIG. 2) in adjusting threshold levels. For example, the properties of temperature may be different in a small room than in a big room. In order to accommodate use of the electronic device in different sized rooms, it is necessary to account for the dimensions of the room the electronic device is located in. In one embodiment, threshold logic 240 of FIG. 2 requires room dimension setting 330 to properly calculate the appropriate threshold levels.

Shutdown time setting 340 allows a user to determine a time period that delays the initiation of an automatic shutdown. In one embodiment, a timer begins when motion or heat falls below their respective threshold level. Upon the passing of the shutdown time period, the device automatically turns off. In another embodiment, a timer begins when motion and heat both fall below their respective threshold levels. Upon the passing of the shutdown time period, the device automatically turns off. For example, a user may desire a five minute shutdown delay. Upon the passing of five minutes of no interactivity with the electronic device (e.g. motion and heat below the respective threshold levels), the electronic device automatically shuts off.

Shutdown warning time setting 350 allows a user to determine the-time prior to automatic shutdown that the user is prompted with a warning cue that automatic shutdown is imminent. This allows a user time to move or enter the room where the electronic device is located prior to automatic shutdown. In one embodiment, the warning cue is an audible cue. For example, the warning cue is a series of beeps, an audible countdown, or an audible message (e.g. “shutdown in fifteen seconds.”) In another embodiment, the warning cue is a visual cue. For example, a countdown timer may be displayed on a television screen, or an image of a waving hand will appear on the screen (e.g. a user would wave back to reset the shutdown timer.)

It should be appreciated that there are any number of personalization features that can be applied to the present invention, and the above list is not meant to limit the number or scope of user-defined settings. In one embodiment, the shape of the room is a user-defined setting, thus allowing for greater accuracy in determining threshold sensitivity levels. In another embodiment, the height and angle of any sensors (e.g. heat sensor 103 and motion sensor 104 of FIG. 1) can be adjusted. For example, a user with a dog may raise the sensor angle so that when the dog enters the room with the electronic device, it does not interfere with the automatic shutdown countdown. In another embodiment, the electronic device is configured to automatically turn on when motion or heat exceeds the respective threshold sensitivity level (e.g. when someone enters the room where the electronic device is located).

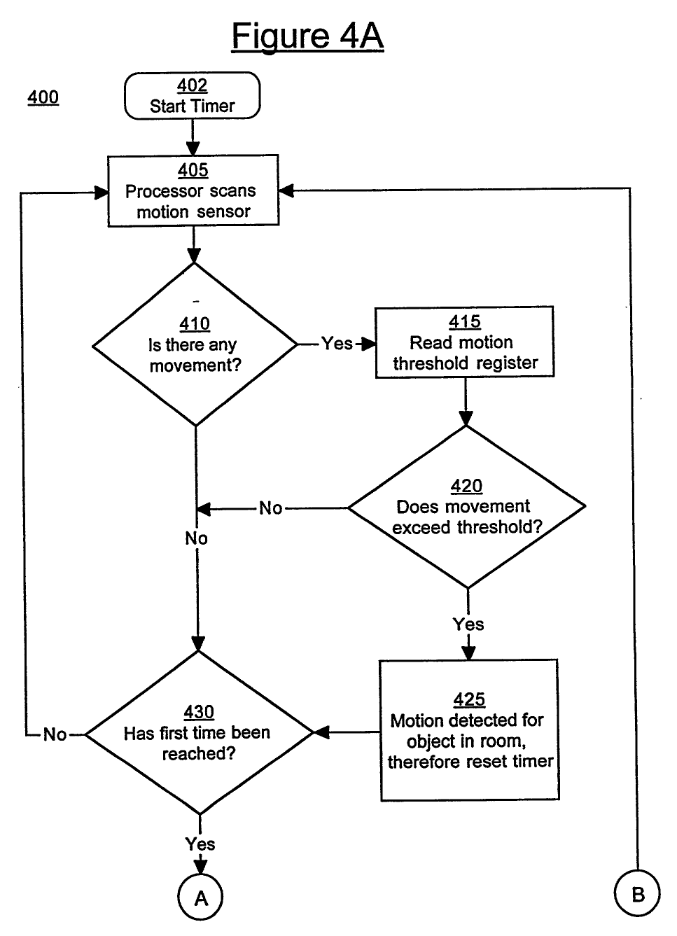

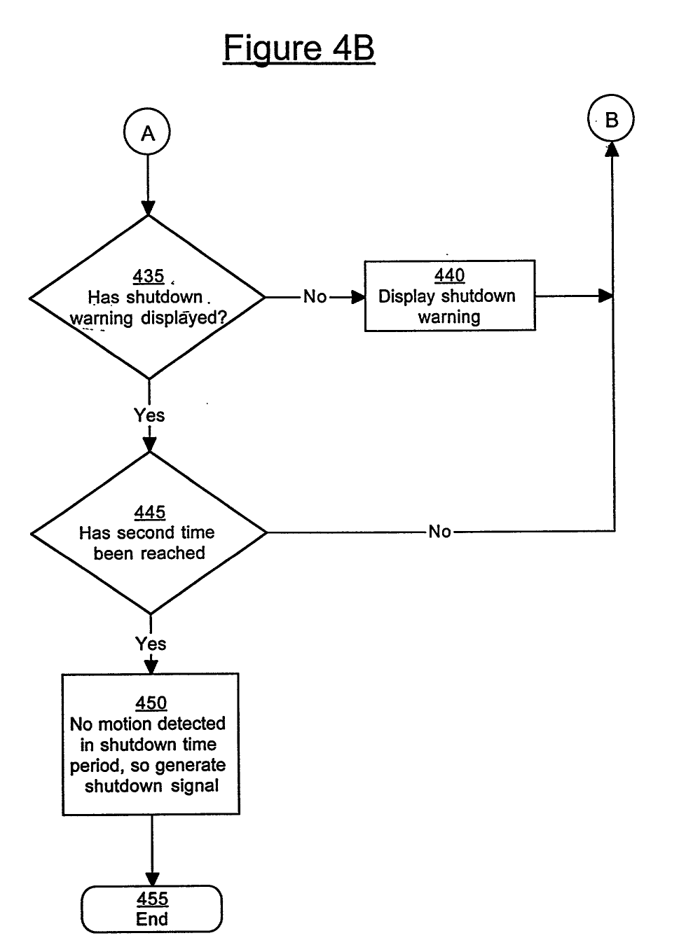

FIGS. 4A and 4B are flowcharts showing steps of a computer implemented process 400 for generating a shutdown signal for an electronic device when motion falls below a threshold level in accordance with one embodiment of the present invention. In one embodiment, process 400 is thread that operates parallel to other programs operating on the electronic device. Process 400 continuously cycles through until a shutdown signal is generated (see step 455).

At step 402 of process 400, a self-counting timer starts. At step 405 of process 400, a processor scans a motion sensor (e.g. motion sensor 104 of FIG. 1). In one embodiment, the motion sensor is integral to the electronic device.

At step 410, the processor determines whether or not the sensor has detected any movement. If no movement is detected, the process goes directly to step 430.

If there has been movement detected, as shown at step 415, the processor reads the motion threshold register. The motion threshold register (e.g. motion threshold register 225 of FIG. 2) comprises the motion threshold level.

At step 420, it is determined whether the movement detected exceeds the motion threshold level. If the motion detected exceeds the motion threshold level, as shown at step 425, the self-counting timer is reset. If the motion detected does not exceed the motion threshold level, the process goes directly to step 430.

At step 430, it is determined whether a shutdown warning time period has been reached. In one embodiment, the shutdown warning time period is a user-defined time period (e.g. shutdown warning time setting 350 of FIG. 3) for prompting the user with a shutdown warning message. If it is determined that the shutdown warning time period has not been reached, the process returns to step 405 to continue scanning for movement.

If it is determined that the shutdown warning time period has been reached, the process goes to step 435. At step 435, it is determined whether or not a shutdown warning message has been displayed. If it is determined that the shutdown warning message has not been prompted yet, as shown at step 440, the shutdown warning is prompted.

In one embodiment, the shutdown warning message notifies the user that the electronic device will be shut off at the completion of a second time period. In one embodiment, the shutdown warning cue is an audible cue. In one embodiment, the warning cue may be a series of beeps, an audible countdown, or an audible message (e.g. “shutdown in fifteen seconds.”) In another embodiment, the shutdown warning cue is a visual prompt. For example, a countdown timer may be displayed on a television screen, or an image of a waving hand will appear on the screen (e.g. a user would wave back to reset the shutdown timer.)

Once the shutdown warning message has been prompted, the process returns to step 405 to continue scanning for movement.

If it is determined that the shutdown warning has been prompted, it is then determined whether a shutdown time has been reached. In one embodiment, the second shutdown period is a user-defined time period (e.g. shutdown time setting 340 of FIG. 3) for automatically shutting off the electronic device. If it is determined that the shutdown time period has not been reached, the process returns to step 405 to continue scanning for movement.

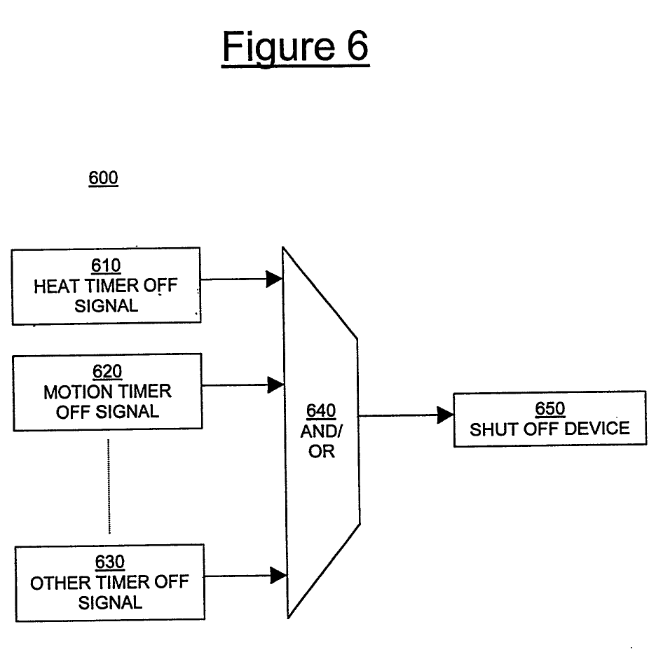

If it is determined that the shutdown time period has been reached (e.g. no movement has been detected in the shutdown time period), as shown at step 450, a shutdown signal is generated. In one embodiment, the shutdown signal operates to automatically turn the electronic device off. In another embodiment, as shown in FIG. 6, supra, the shutdown signal is sent to an and/or circuit (e.g. and/or gate 640 of FIG. 600). Once a shutdown signal is generated, as shown at step 455, process 400 ends.

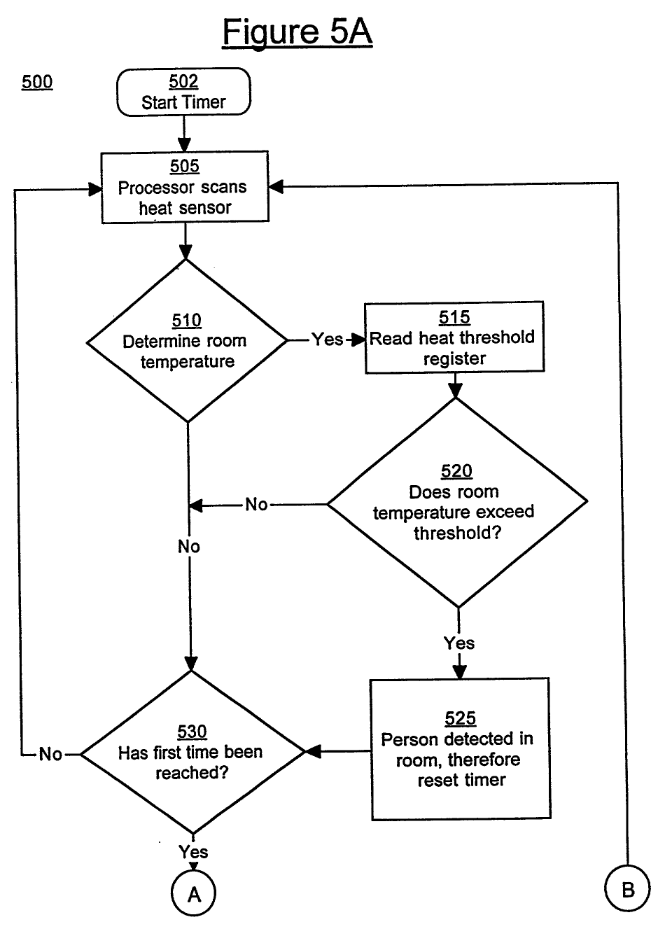

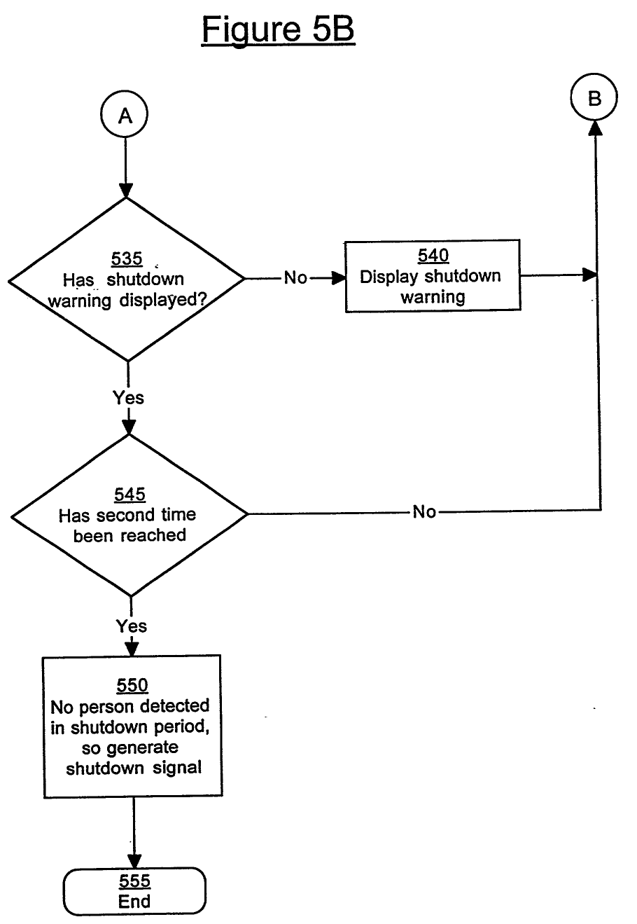

FIGS. 5A and 5B are flowcharts showing steps of a computer implemented process 500 for generating an off signal for an electronic device when temperature falls below a threshold level in accordance with one embodiment of the present invention. Process 500 operates in much the same manner as process 400 of FIG. 4. In one embodiment, process 500 scans for a change in temperature, and generates a shutdown signal if the temperature falls below a heat threshold level for a predetermined period of time (e.g. shutdown time 340 of FIG. 3).

In one embodiment, a thread running concurrent to process 400 and process 500 monitors for a user actively interacting with the electronic device (e.g. changing the channels or adjusting the volume on a television). Upon a user actively interacting with the electronic device, the self-counting timer is automatically reset.

The present invention operates by making inferences regarding a user interactivity with an electronic device by monitoring movement and temperature in an area proximate to an electronic device. If there is no movement in the vicinity of the electronic device, the present invention infers that no person is using the electronic device. Likewise, if the temperature falls below a certain threshold level, the present invention infers that no person is using the electronic device.

FIG. 6 is a block diagram illustrating an operation 600 for turning off an electronic device upon the generation of off signals in accordance with one embodiment of the present invention. Operation 600 allows a user to determine what combination of shutdown signals are required to shutdown an electronic device.

In one embodiment, and/or circuit 640 receives heat timer off signal 610 and motion timer off signal 620 (e.g. shutdown signal of step 450 of FIG. 4). And/or circuit 640 may also receive other timer off signal 630. It should be appreciated that

In one embodiment, a user defines a combination of shutdown signals that operates to shutdown the electronic device.

In one embodiment, once and/or circuit 640 receives any shutdown signal, the electronic device is automatically turned off. For example, if there is not movement in the room above a motion threshold level detected for a predetermined period of time, but the temperature detected does not fall below a heat threshold level, the device is automatically turned off (e.g. a person falls asleep while watching television).

In another embodiment, and/or circuit must receive all shutdown signals before the electronic device is automatically shut off. For example, only upon there being no movement and temperature below threshold levels for a predetermined time will the electronic device automatically shut off (e.g. no person is in the room where the device is located).

The present invention provides for a method and a device thereof for automatically turning off a passively used electronic device when it is not being used, therefore reducing power costs and wear on the components of the electronic device. The present invention also provides for a method and a device thereof that is user friendly and convenient for a user to operate. The present invention also provides for a method and a device thereof that is easily integrated into current consumer electronic devices. The present invention also provides for a method and a device thereof that is commercially economical.

While the present invention has been described in particular embodiments, it should be appreciated that the present invention should not be construed as limited by such embodiments, but should be construed according to the claims below.

What is claimed is:

1. A method for automatically turning an electronic device off comprising the steps of:
a) detecting a level of motion within a predetermined area, said area containing said electronic device;
b) detecting a level of heat within said area; and
c) in response to said level of motion below a first threshold and said level of heat below a second threshold, automatically turning off said electronic device.

2. The method as recited in claim 1 further comprising the step of activating a timer in response to said level of motion below said first threshold and said level of heat below said second threshold.

3. The method as recited in claim 2 wherein said step c) comprises the step of automatically turning off said electronic device provided said level of motion remains below said first threshold and said level of heat remain below said second threshold for a first predetermined time period.

4. The method as recited in claim 3 wherein said step c) further comprises the step of notifying a user of said electronic device, irrespective of said user's activity on said electronic device, upon said timer reaching a second predetermined time period, said second predetermined time period being of shorter duration than said first predetermined time period that upon said timer reaching said first predetermined period that said electronic device will be turned off.

5. The method as recited in claim 1 wherein said first threshold and said second threshold are defined by a user.

6. The method as recited in claim 3 wherein said first predetermined time period is defined by a user.

7. The method as recited in claim 4 wherein said second predetermined time period is defined by a user.

8. The method as recited in claim 1 wherein said electronic device is a television.

9. The method as recited in claim 4 wherein said step of notifying includes the step of activating an audible prompt.

10. The method as recited in claim 4 wherein said step of notifying includes the step of displaying a message on a screen of said electronic device.

11. The method as recited in claim 10 wherein said message is an image of a waving hand.

12. An electronic device having an automatic turn off feature comprising:
a processor;
a memory unit coupled to said processor;
said memory having computer-readable program code embodied therein for causing said processor to perform a method for automatically turning off, said method comprising the steps of:
a) detecting a level of motion within a predetermined area, said area containing said electronic device;
b) detecting a level of heat within said area; and
c) in response to said level of motion below a first threshold and said level of heat below a second threshold, automatically turning off said electronic device.

13. The electronic device as recited in claim 12 wherein in response to said level of motion below said first threshold and said level of heat below said second threshold, said processor is further adapted for activating a timer.

14. The electronic device as recited in claim 13 wherein provided said level of motion remains below said first threshold and said level of heat remain below said second threshold for a first predetermined time period, upon said timer reaching said first predetermined time period said processor is further adapted for automatically turning off said electronic device.

15. The electronic device as recited in claim 14 wherein upon said timer reaching a second predetermined time period, said second predetermined time period being of shorter duration than said first predetermined time period, said processor is adapted for notifying a user of said electronic device, irrespective of said user's activity on said electronic device, that upon said timer reaching said first predetermined period that said electronic device will be turned off.

16. The electronic device as recited in claim 12 wherein said first threshold and said second threshold are defined by a user.

17. The electronic device as recited in claim 14 wherein said first predetermined time period is defined by a user.

18. The electronic device as recited in claim 15 wherein said second predetermined time period is defined by a user.

19. The electronic device as recited in claim 12 further comprising a motion sensor and a heat sensor.

20. The electronic device as recited in claim 12 wherein said electronic device is a television.

21. The electronic device as recited in claim 15 wherein said step of notifying operates to activate an audible prompt.

22. A method for automatically turning an electronic device off comprising the steps of:
a) automatically detecting using at least one sensor as an indicator that a user is within a predetermined area containing said electronic device and interacting with said electronic device, and
b) automatically turning off said electronic device provided said user is not interacting with said electronic device.

23. The method as recited in claim 22 wherein said step b) comprises the step of automatically turning off said electronic device provided said user is not interacting with said electronic device for a predetermined time period.

24. The method as recited in claim 23 wherein said step b) comprises the step of notifying said user irrespective of said user's activity on said electronic device that said electronic device will be turned off upon the user not interacting with said electronic device for said predetermined time period.

25. The method as recited in claim 22 wherein said sensor is a motion sensor.

26. The method as recited in claim 22 wherein said sensor is a heat sensor.

27. The method as recited in claim 22 wherein said electronic device is a television.

28. The method as recited in claim 22 wherein said predetermined time period is defined by a user.

29. The method as recited in claim 24 wherein step of notifying operates to activate an audible prompt.
